(19) United States
(12) Patent Application Publication
(10) Pub. No.: US 2003/0165262 A1
(43) Pub. Date: Sep. 4, 2003

(54) Detection of calcifications within a medical image

(75) Inventors: Robert M. Nishikawa, Chicago, IL (US); Maria Fernanda Salfity, Rosario (AR); Yulei Jiang, Chicago, IL (US); John Papaioannou, Chicago, IL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: The University of Chicago, Chicago, IL

(21) Appl. No.: 10/078,694

(22) Filed: Feb. 21, 2002

(51) Int. Cl. G06K 9/00

(52) U.S. Cl. 382/128

(57) ABSTRACT

A method of detecting a calcification in a bounding box enclosing a portion of a medical image, including the steps of obtaining the medical image in digital form, filtering at least image data in the bounding box using a difference of Gaussians (DOG) filter, and thresholding the filtered image data to detect, as one or more calcifications, portions of the filtered image data which exceed a threshold. The detected calcification may be classified by segmenting the one or more detected calcifications, extracting at least one feature from the one or more segmented calcifications, and determining a likelihood of malignancy of the one or more detected calcifications.

The present invention was made in part with U.S. Government support under grant number CA 60187 from the National Cancer Institute. The U.S. Government may have certain rights to this invention.

### BACKGROUND OF THE INVENTION

1. Field of the Invention

The invention relates generally to the computerized, automated assessment of medical images, (e.g., ultrasound images such as mammograms), and more particularly to methods, systems, and computer program products for precisely locating clusters of calcifications within a medical image.

The present invention also generally relates to computerized techniques for automated analysis of digital images, for example, as disclosed in one or more of U.S. Pat. Nos. 4,839,807; 4,841,555; 4,851,984; 4,875,165; 4,907,156; 4,918,534; 5,072,384; 5,133,020; 5,150,292; 5,224,177; 5,289,374; 5,319,549; 5,343,390; 5,359,513; 5,452,367; 5,463,548; 5,491,627; 5,537,485; 5,598,481; 5,622,171; 5,638,458; 5,657,362; 5,666,434; 5,673,332; 5,668,888; 5,732,697; 5,740,268; 5,790,690; 5,832,103; 5,873,824; 5,881,124; 5,931,780; 5,974,165; 5,982,915; 5,984,870; 5,987,345; 6,011,862; 6,058,322; 6,067,373; 6,075,878; 6,078,680; 6,088,473; 6,112,112; 6,138,045; 6,141,437; 6,185,320; 6,205,348; 6,240,201; 6,282,305; 6,282,307; 6,317,617 as well as U.S. patent application Ser. Nos. 08/173,935; 08/398,307 (PCT Publication WO 96/27846); 08/536,149; 08/900,189; 09/027,468; 09/141,535; 09/471,088; 09/692,218; 09/716,335; 09/759,333; 09/760,854; 09/773,636; 09/816,217; 09/830,562; 09/818,831; 09/842,860; 09/860,574; 60/160,790; 60/176,304; and 60/329,322; co-pending applications (listed by attorney docket number) 215752US-730-730-20; 215807US-730-730-20; 215808US-730-730-20; 206439US-730-730-20; and 216504US-730-730-20 PROV; and PCT patent applications PCTIUS98/1516; PCT/US98/24933; PCT/US99/03287; PCT/US00/41299; PCT/USO1/00680; PCTIUSO1/01478 and PCT/USO1/01479, all of which are incorporated herein by reference.

The present invention includes use of various technologies referenced and described in the above-noted U.S. Patents and Applications, as well as described in the references identified in the following LIST OF REFERENCES by the author(s) and year of publication and cross referenced throughout the specification by reference to the respective number, in parentheses, of the reference:

### LIST OF REFERENCES

1. S. A. Feig, “Decreased Breast Cancer Mortality Through Mammographic Screening: Results of Clinical Trials,” Radiology, vol. 167, pp. 659-665, 1988.

2. C. R. Smart, R. E. Hendrick, J. H. Rutledge and R. A. Smith, “Benefit of Mammography Screening in Women Ages 40 to 49 Years: Current Evidence from Randomized Controlled Trials,” Cancer, vol. 5, pp. 1619-26, 1995.

3. CancerNet 2000, a service of the National Cancer Institute. Available: www.cancemet.nci.nih.gov.

4. E. A. Sickles, “Mammographic Features of 300 Consecutive Nonpalpable Breast Cancers,” Am. J Roentgenol., vol. 146, pp. 661-663, 1986.

5. A. M. Knutzen and J. J. Gisvold, “Likelihood of Malignant Disease for Various Categories of Mammographicaly Detected, Nonpalpable Breast Lesions,” in Mayo Clin. Proc., 1993, vol. 68, pp. 454-460.

6. K. Doi, M. L, Giger, R. M. Nishikawa, K. R. Hoffmann, H. MacMahon, R. A. Schmidt, and K. G. Chua, “Digital Radiography. A Useful Clinical Tool for Computer-aided Diagnoses by Quantitative Analysis of Radiographic Images,” Acta Radiologica, vol. 34, pp. 426-439, 1993.

7. Y. Wu, M. L. Giger, K. Doi, C. J. Vyborny, R. A. Schmidt, and C. E. Metz, “Artificial Neural Networks in Mammography: Application to Decision Making in the Diagnosis of Breast Cancer,” Radiology, vol. 187, pp. 81-87, 1993.

8. Y. Jiang, R. M. Nishikawa, D. E. Wolverton, C. E. Metz, M. L. Giger, R. A. Schmidt, C. J. Vyborny, and K. Doi, “Malignant and benign clustered microcalcifications: automated feature analysis and classification,” Radiology, vol. 198, pp. 671-678, 1996.

9. J. A. Baker, P. J. Kornguth, J. Y. Lo, and C. E. J. Floyd, “Artificial neural network: improving the quality of breast biopsy recommendations,” Radiology, vol. 198, pp. 131-135, 1996.

10. H. -P. Chan, B. Sahiner, N. Petrick, M. A. Helvie, K. L. Lam, D. D. Adler, and M. M. Goodsitt, “Computerized classification of malignant and benign microcalcifications on mammograms: texture analysis using an artificial neural network,” Phys. Med. Biol, vol. 42, pp. 549-567, 1997.

11. D. J. Getty, R. M. Pickett, C. J. D'Orsi, and J. A. Swets, “Enhanced interpretation of diagnostic images,” Invest. Radiol., vol. 23, pp. 240-252, 1988.

12. Y. Jiang, R. M. Nishikawa, R. A. Schimdt, C. E. Metz, M. L. Giger, and K. Doi, “Improving breast cancer diagnosis with computer-aided detection,” Acad. Radiol., vol. 6, pp. 22-33, 1999.

13. H. P. Chan, B. Sahiner, M. A. Helvie, N. Petrick, M. A. Roubidoux, T. E. Wilson, D. D. Adler, C. Paramagul, J. S. Newman, and S. Sanjay-Gopal, “Improvement of radiologists' characterization of mammographic masses by using computer-aided diagnosis: an ROC study,” Radiology, vol. 212, pp. 817-827, 1999.

14. H. -P. Chan, K. Doi, C. J. Vyborny, H. MacMahon, and P. M. Jokich, “Image feature analysis and computer-aided diagnosis in digital radiography. 1. Automated detection of microcalcifications in mammography,” Med. Phys., vol. 14, pp. 538-548, 1987.

15. H. -P. Chan, K. Doi, C. J. Vyborny, R. A. Schmidt, C. E. Metz, K. L. Lam, T. Ogura, Y. Wu, and H. MacMahon, “Improvement in radiologists' detection of clustered microcalcifications on mammograms: The potential of computer-aided diagnosis,” Invest. Radiol., vol. 25, pp. 1102-1110, 1990.

16. R. M. Nishikawa, M. L. Giger, K. Doi, C. J. Vyborny, and R. A. Schmidt, “Computer-aided detection of clustered microcalcifications: An improved method for grouping detected signals,” Med. Phys., vol. 20, 1660-1666, 1993.

17. R. M. Nishikawa, Y. Jiang, M. L. Giger, R. A. Schmidt, C. J. Vyborny, W. Zhang, J. Papaioannou, U. Bick, R. Nagel, and K. Doi, “Performance of automated CAD methods for the detection and classification of clustered microcalcifications,” in Proc. Int. Workshop Digital Mammography, pp. 13-20, 1994.

18. W. Zhang, K. Doi, M. L. Giger, R. M. Nishikawa, and R. A. Schmidt, “An improved shift-invariant artificial neural network for computerized detection of clustered microcalcifications in digital mammograms,” Meds. Phys., vol. 23, pp. 595-601, 1996.

19. R. H. Nagel, R. M. Nishikawa, J. Papaioannou, and K. Doi, “Analysis of methods for reducing false positives in the automated detection of clustered microcalcifications in mammograms,” Med. Phys., vol. 25, pp. 1502-1506.1998.

20. R. M. Nishikawa, M. L. Giger, D. E. Wolverton, R. A. Schmidt, and K. Doi, “Prospective testing of a clinical CAD workstation for the detection of breast lesions on mammograms,” in Proc. Int. Workshop Computer-Aided Diagnosis, pp. 209-214, 1998.

21. Y. Jiang, R. M. Nishikawa, and J. Papaioannou, “Dependence of computer classification of clustered microcalcifications on the correct detection of microcalcifications,” Med. Phys., vol. 28, pp. 1949-1957, 2001.

22. American College of Radiology, Breast Imaging Reporting and Data System, (American College of Radiology, Reston, Va., 1998).

23. J. C. Russ, The Image Processing Handbook, Florida, CRC Press, 1992, pp. 131.

24. C. E. Metz, “ROC methodology in radiologic imaging,” Invest. Radiol., vol. 21, pp. 720-733, 1986.

25. C. E. Metz, “Some practical issues of experimental design and data analysis in radiological ROC studies,” Invest. Radiol., vol. 24, pp. 234-245, 1989.

26. Y. Jiang, C. E. Metz, and R. M. Nishikawa, “A receiver operating characteristic partial area index for highly sensitive diagnostic tests,” Radiology, vol. 201, pp. 745-750, 1996.

27. D. C. Edwards, M. A. Kupinski, R. Nagel, R. M. Nishikawa, and J. Papaioannou, “Using a Bayesian Neural Network to optimally eliminate false-positive microcalcification detections in a CAD method,” in Proc. Int. Workshop Digital Mammography, pp. 168-173, 2000.

28. Z. Huo, and J. L. Giger, “Evaluation of a computer segmentation method based on performances of an automated classification method,” Proc. SPIE, vol. 3981, pp. 16-21.

29. Jiang Y, Nishikawa R M, Giger M L, Doi K, Schmidt R A, Vyborny C J. “Method of Extracting Signal Area and Signal Thickness of Microcalcifications from Digital Mammograms,” Proc. SPIE 1992; 1778: 28-36.

30. Dougherty, Edward R. “An Introduction to Morphological Image Processing,” SPIE Optical Engineering Press, 120-121 (1992).

The contents of each of these references are incorporated herein by reference. The techniques disclosed in the patents and references may be utilized as part of the present invention.

### DISCUSSION OF THE BACKGROUND

Screening mammography is the best available tool for detecting cancerous lesions before clinical symptoms appear and it has been shown to reduce breast cancer mortality. (See References 1 and 2). Because approximately one-half of all cancers detected by mammography correspond to clustered microcalcifications, these lesions are considered to be mammographic hallmarks of early breast cancer. (See Reference 3). Microcalcifications are small calcium deposits, typically a few hundred microns in diameter. Usually the shape and the arrangement of microcalcifications help the radiologist to judge the likelihood of cancer being present. However, because of the small size of microcalcifications and the difficulty in distinguishing very slight differences in the appearance of benign and malignant clusters, the differentiation of benign and malignant lesions represents a very complex problem. In fact, it has been reported that only ten to thirty-five percent of breast biopsies yield cancer. (See References 4 and 5).

Computer-aided diagnosis (CAD) is a diagnosis made by a radiologist who considers the results of an automated computer analysis of an image. (See Reference 6). CAD may potentially help radiologists improve the diagnosis of malignant and benign breast lesions and, as a consequence, may reduce the number of biopsies performed on benign lesions. (See References 7-10). Several researchers have shown statistically that radiologists' performance in distinguishing benign from malignant calcifications is significantly improved when they use a computer aid. (See References 11-13). Researchers at the University of Chicago developed a computerized method for the classification of clustered microcalcifications. (See Reference 8). Eight features, related to microcalcification size, shape, quantity, and spatial distribution, are automatically extracted from the image. These features include, but are not limited to: area of the cluster, shape of the cluster, number of calcifications in the cluster, average effective volume of microcalcifications (for individual calcifications and for the cluster), relative standard deviation in effective volume (for individual calcifications and for the cluster), relative standard deviation in effective thickness (for individual calcifications and for the cluster), average area of microcalcifications (for individual calcifications and for the cluster), and the shape of the microcalcifications. (See References 8 and 29). An artificial neural network (ANN) combines these features to produce an estimate of the likelihood of malignancy of each cluster present in the image. This estimated likelihood may then be used by a radiologist as a second opinion to decide whether the microcalcification cluster is malignant or benign. In an observer study, the biopsy recommendations of ten radiologists were compared when they read the mammograms with and without the computer aid. (See Reference 12). Results showed a statistically significant improvement in performance when radiologists used the computer output as compared to when they did not. The computer method enabled the radiologists to reduce the number of biopsy recommendations on benign lesions by ten percent while simultaneously correctly diagnosing fourteen percent more cancers. Results from this observer study indicate that CAD may be used to help radiologists in the task of making biopsy recommendations by reducing both the number of unnecessary biopsies and the number of false negative diagnoses.

The feature extraction process of this classification method requires as input the x and y locations of each microcalcification, i.e., the Cartesian coordinate locations of each microcalcification. These candidate microcalcifications are first segmented, then features related to individual microcalcifications are determined, and finally cluster related features are calculated. In previous studies, the locations of the microcalcifications were determined manually. Localizing each calcification in a manual fashion is a time-consuming task and would not be practical for clinical implementation, considering that the number of calcifications in a cluster can be 100 or even higher. Therefore, the automatic identification of the calcifications prior to the classification of clusters is desired.

Researchers at the University of Chicago also developed a cluster-detection method. (See References 14-20). In order to determine the presence of a cluster in a mammogram, it is not necessary to identify all calcifications. In fact, the average number of calcifications detected by the cluster-detection method is about forty percent, with twenty percent false positives. (See Reference 21). However, the number of calcifications that are identified in a cluster is relevant for classification purposes. Features such as the number of calcifications, the cluster size, and the mean calcification area are used to distinguish benign from malignant clusters, and their values will depend upon the accuracy of the detection of individual microcalcifications. For these reasons, the cluster-detection and the cluster-classification methods have not yet been merged in to a single unit.

Jiang et al. studied the dependence of the ANN classification method on the correct detection of individual calcifications. (See Reference 21). They found that if the average number of calcifications input to the classifier is above forty percent of the actual calcifications, with an average fraction of false signals below fifty percent, the performance of the ANN does not vary significantly from the performance of five radiologists. Training the ANN with computer-detected microcalcifications was also shown to degrade the performance of the classification method.

### SUMMARY OF THE INVENTION

Accordingly, an object of this invention is to provide a method, system, and computer program product for the automated localization of clustered calcifications in order to generate the input for a classification method including an artificial neural network.

This and other objects are achieved by way of a method, system, and computer program product constructed according to the present invention, wherein a calcification-detection method is presented that automatically localizes calcifications in a previously detected cluster and generates the input for a cluster-classification method.

In particular, according to one aspect of the present invention, there is provided a novel method of localizing calcifications within a cluster and generating the input for the cluster-classification method using three pieces of a priori information: the location of the center of the cluster, the size of the cluster, and the approximate number of calcifications in the cluster.

According to other aspects of the present invention, there are provided a novel system implementing the method of this invention and a novel computer program product, which upon execution causes the computer system to perform the above method of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1(a) is a flowchart of the calcification-detection method with an end step of a detected calcification;

FIG. 1(b) is a flowchart of the classification method with the inputted detected calcification coming from the end step of FIG. 1(a);

FIG. 2 is a graph illustrating the Free Response Operating Characteristic (FROC) curve of the calcification-detection method on Database I, where the numbers indicate the value of k associated with each point;

FIGS. 3(a)-3(d) illustrate the area A_{Z} and the partial area _{0.90}A_{Z} indices obtained on Database I when the classifier input is provided by the calcification-detection method, shown as a function of the threshold parameter k. The A_{Z} and _{0.90}A_{Z} values obtained when manual identifications are used and when the cluster-detection method is used are included for comparison. FIG. 3(a) shows A_{Z} on a per patient analysis; FIG. 3(b) shows _{0.90}A_{Z} on a per patient analysis; FIG. 3(c) shows A_{Z} on a per cluster analysis; and FIG. 3(d) shows _{0.9}A_{Z} on a per cluster analysis;

FIGS. 4(a)-4(b) illustrate ROC curves obtained on Database I: FIG. 4(a) shows a per patient basis and FIG. 4(b) shows on a per cluster basis, when the input of the classification method is given by the calcification-detection method;

FIGS. 5(a)-5(b) show ROC curves obtained on Database I: FIG. 5(a) shows a per patient basis and FIG. 5(b) shows a per cluster basis, when the input of the classification method is given by manual identifications, by the calcification-detection method, and by the cluster-detection method; and

FIG. 6 is a graph showing FROC curves of the calcification-detection method for benign and malignant clusters in Database I.

### DETAILED DESCRIPTION OF THE PREFERRED EMBODIMENTS

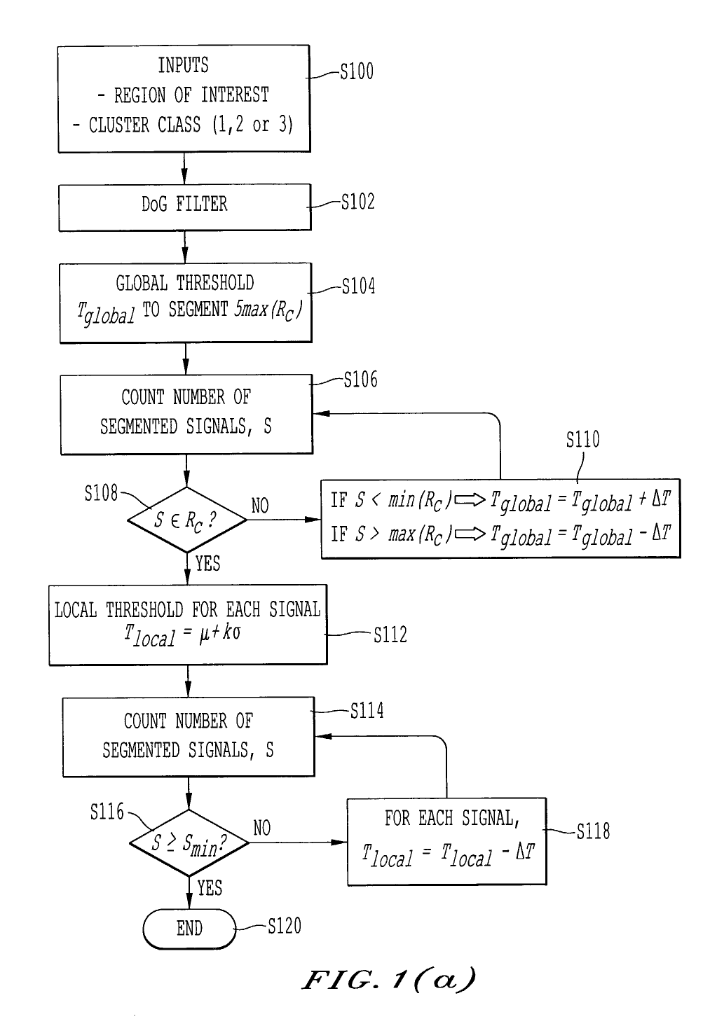

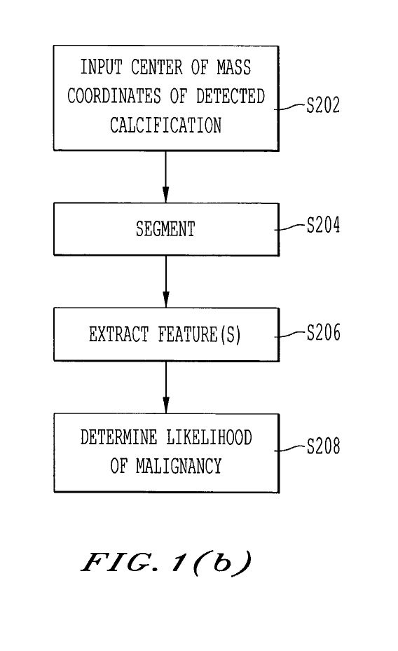

Referring now to the drawings, wherein like reference numerals designate identical or corresponding parts throughout the several views, FIG. 1(a) discloses a method of calcification-detection.

Therefore, presented herein is a method for a more precise localization of the calcifications once a cluster is detected in order to automatically generate the input for the cluster-classification method. This new method will be referred to as a calcification detection method to differentiate from the cluster-detection method. Two independent mammogram databases were used in this study. Each film contained at least one cluster of microcalcifications. Each cluster had been proven, through biopsy, to be either benign or malignant. Database I consisted of 100 mammograms from 53 patients. The mammograms were digitized with a Fuji drum scanner with a gray-scale resolution of 10 bits and a pixel size and sampling rate of 0.1 mm/pixel. There were a total of 107 clusters (40 malignant, 67 benign) in this database. Jiang et al. reported the performance of five radiologists in the rating of malignancy potential of the clustered microcalcifications, which shows that a large number of these cases were difficult to diagnose. (See Reference 8). Database II consisted of 237 mammograms from 131 patients. The films were digitized with a Lumiscan-100 (Lumisys, Sunnyvale, Calif.) scanner with the same spatial and gray-scale resolution and sampling rate as for Database I. There were 246 microcalcification clusters (123 malignant, 123 benign) in this set of images.

For each cluster in both databases, a researcher manually identified the microcalcifications by using a high-quality computer monitor and by referencing the film mammograms. For each cluster, its bounding box, the smallest rectangle that contains the entire cluster, was determined by using the manually identified calcifications. A region of interest (ROI) was then defined as the bounding box combined with a 55-pixel margin surrounding it. The ROI was then extracted. The additional margin is used to calculate the features for input to the ANN cluster classifier. Database I was used to determine the parameters of the calcification-detection method. Database II was used to evaluate the performance of the resulting method.

A flowchart of the calcification-detection method is shown in FIG. 1(a). The method requires two inputs: a bounding box or an ROI that contains a cluster of microcalcifications and the class to which the cluster belongs according to its number of calcifications, N, as shown in S100. Three classes are used: Class 1 (N<6); Class 2 (6≦N≦10); and Class 3 (N>10). This information is used to devise a more accurate calcification segmentation procedure. Thresholding techniques are improved based upon ranges estimated using the predetermined cluster classes.

The calcifications are first enhanced by means of a filter, such as a Difference of Gaussians (DOG), wavelet, box-rim, bandpass, or similar filter, and then segmented using global and local thresholdings. (See References 15, 23, and 30). In a preferred embodiment, the DOG filter smoothes the image with two Gaussian kernels of different standard deviations, σ₁ and σ₂, and then subtracts one smoothed version of the image from the other smoothed version of the image in S102. A subset of ten representative images from Database I was used to select the values of σ₁=1.1 and σ₂=1.4, with kernel sizes of 7×7 and 9×9, respectively. With these parameters, the effect of the filter is to enhance structures of the typical microcalcification of size 3×3 pixels.

The enhanced potential calcifications (hereafter referred to as “signals”) are then segmented by global and local thresholding, shown in steps S104 through S118. The global thresholding retains a number of signals within the range R_{c}, where R_{c} depends on the cluster class, and the minimum and maximum boundaries of R_{c} are well above the expected number of calcifications, N, as shown in Table 1. N may be determined manually or may be determined automatically. Automatic determination of N may be performed, for example, by a cluster detection scheme. (See References 14-19). Global thresholding may be performed iteratively. In step S104, the initial global threshold T_{global} is set equal to a gray level such that the number of pixels above it is equal to five times the upper limit of R_{c}, It is assumed that the average signal size is five pixels, which correlates to typical calcification areas. After the initial thresholding in step S104, the number of candidate calcifications, S, are counted, as shown in step S106. Signals with an area of 1 pixel or larger than 100 pixels are excluded because they are not likely to be actual microcalcifications. Signals within 55 pixels from the edge of the ROI are also ignored because this area is not part of the cluster bounding box. In step S108, it is determined if S lies within R_{c}. If S does not lie within R_{c}, T_{global} is increased or decreased in step S110 by a small step, ΔT, where ΔT is selected empirically as 0.1. The gray level of the image is no longer quantized as in the original image after the DOG filtering. This process is repeated until the number of signals S falls within R_{c}, (YES at the output of step S108).

The local thresholding is commenced in step S112 and applied to the retained signals in order to reduce false-positives. In this step, a minimum number of signals, Sₘᵢₙ, is always segmented where Sₘᵢₙ depends on the cluster class as shown in Table 1.

TABLE 1
Parameters of the calcification-detection scheme.

| | | | Minimum number |
|---|---|---|---|
| Cluster | Number of true | Range R_{c} for global | of signals Sₘᵢₙ, for |
| Class | calcifications, N | threshold | local threshold |
| 1 | N < 6 | [30, 50] | 3 |
| 2 | 6 ≦ N ≦ 10 | [50, 100] | 6 |
| 3 | N > 10 | [100, 200] | 11 |

The local thresholding is also performed iteratively. Centered on each signal identified in the previous step, a 100×100 pixels box is defined. In this box, in step S112 the mean μ and standard deviation σ of the background gray levels are calculated by excluding those pixels that are identified in the global threshold step as potential signals. The initial local threshold T_{local} is set equal to (μ+kσ), where k is a variable parameter in step S112. If the maximum gray level of the signal is below T_{local}, the signal is discarded. Once all signals are analyzed using this method, in step S116 the number of remaining signals S is compared to Sₘᵢₙ, as shown in Table 1. If S<Sₘᵢₙ in step S118 T_{local} is decreased by ΔT. S is again calculated and compared to Sₘᵢₙ. This process is repeated until S>Sₘᵢₙ, at which point the method ends at step S120.

The output of the calcification-detection method is the center of mass coordinates of detected signals and may be used as input to the classification method. After local thresholding, islands or signals are produced. Each island is represented by a single pixel coordinate that corresponds to the center of mass of the island. (See Reference 8). Islands, which represent candidate abnormalities, are located at the center of mass coordinates.

The performance of the computerized detection of individual calcifications is evaluated by counting the number of signals that match actual calcifications (true positive signals) and the number of signals that do not correspond to actual calcifications (false positive signals). A signal is considered a true positive if its center of mass lay within five pixels from an actual calcification. True positive detection, TPDs, may be defined as the ratio of the number of true positive signals to the total number of calcifications present in the cluster. (See Reference 21). Similarly, false positive detection, FPDs, may be defined as the ratio of the number of false positive signals to the total number of calcifications present in the cluster. Therefore, for manually identified calcifications, TPDs=100% and FPDs=0%.

Computerized Classification of Clustered Microcalcifications

FIG. 1(b) illustrates the classification method. The classification method requires as input the x and y locations of the centers of mass of the microcalcifications, as shown in step S202. The microcalcifications are first segmented in step S204. (See References 8 and 29). To segment the individual microcalcifications, a third-degree polynomial surface is fitted in the ROI to reduce the structure of the breast parenchyma. The ROI is 10×10 mm and is centered on the candidate microcalcification. The microcalcification is then delineated with a region growing technique based on gray-level thresholding. The effective thickness of the microcalcification (physical dimension along an x-ray projection line) is estimated from the signal contrast (mean pixel value above the background) of the isolated microcalcification.

This is done by initially converting the signal contrast in terms of pixel value to contrast in terms of relative exposure using the characteristic curve of the film digitizer and the Hurter and Driffield curve of the screen-film system. Contrast in terms of relative exposure is then converted to effective thickness according to exponential attenuation on the basis of a standard model of the breast and the microcalcification. The standard model assumes a 4 cm thick compressed breast composed of 50% adipose tissue and 50% glandular tissue; a microcalcification composed of calcium hydroxyapatite with a physical density of 3.06 g/mm³; and a 20 keV monoenergetic x-ray beam. Two contrast corrections are applied for better accuracy: compensation for blurring resulting from the screen-film system and the digitization process and compensation for x-ray scatter. Eight features that describe calcifications, both individually and as a cluster, are automatically extracted in step 5206. (See Reference 8). These features include, but are not limited to: area of the cluster, shape of the cluster, number of calcifications in the cluster, average effective volume of microcalcifications (for individual calcifications and for the cluster), relative standard deviation in effective volume (for individual calcifications and for the cluster), relative standard deviation in effective thickness (for individual calcifications and for the cluster), average area of microcalcifications (for individual calcifications and for the cluster), and the shape of the microcalcifications. (See References 8 and 29). These features are fed to a feed-forward ANN with one hidden layer of six units and an output layer of one unit. The ANN output is related to the likelihood of malignancy of the cluster. The output of the classification method, as shown in FIG. 1(b) is the likelihood of malignancy illustrated in step S208.

ANN training is performed with the error-back propagation algorithm in a leave one patient out fashion. All clusters that correspond to one patient are set aside as a test set and the remaining clusters are used for training. This procedure is then repeated for the each patient until all clusters are classified.

The performance of the cluster classifier was compared for inputs provided (a) manually, (b) by the cluster-detection method (automatic identification of both the cluster and the calcifications), and (c) by the calcification-detection method (automatic identification of the calcifications). The ANN was retrained for each set of different input data, i.e., for the features that were extracted when the x and y locations of the individual calcifications were given by (a), (b), and (c). Set (c) included several data sets, each corresponding to a different operating point of the calcification-detection method, as shown in Table 2.

TABLE 2
Performance of the calcification-detection scheme on Database I
for different values of the local threshold parameter k
(± indicate standard deviations).

| k | TPDₛ (%) | FPDₛ (%) |
|---|---|---|
| 2.0 | 91 ± 13 | 187 ± 158 |
| 2.6 | 89 ± 13 | 112 ± 124 |
| 2.8 | 89 ± 13 | 82 ± 97 |
| 3.0 | 87 ± 13 | 60 ± 70 |
| 3.2 | 85 ± 14 | 40 ± 50 |
| 3.4 | 83 ± 14 | 27 ± 36 |
| 3.6 | 82 ± 15 | 20 ± 27 |
| 3.8 | 79 ± 15 | 15 ± 13 |
| 4.0 | 77 ± 14 | 12 ± 20 |
| 4.4 | 73 ± 15 | 8 ± 15 |
| 4.8 | 70 ± 16 | 7 ± 13 |
| 5.2 | 67 ± 17 | 7 ± 12 |
| 5.6 | 66 ± 18 | 7 ± 11 |
| 6.0 | 66 ± 18 | 7 ± 10 |

The performance of classifier was evaluated in two different ways: per patient and per cluster. (See Reference 8). The per cluster analysis was direct because each cluster was given a malignancy rating by the ANN. However, two or more different clusters or the same cluster, imaged in different views, may have been obtained from the same patient. In practice, a radiologist would analyze all clusters in all available views in order to diagnose a patient. The approach used for the per patient analysis was to keep only the maximum malignancy rating of all clusters associated with the same patient. Receiver operating characteristic (ROC) analysis was used to evaluate the performance of the classifier on both the per patient and the per cluster bases. (See References 24 and 25). ROC curves, the area A_{Z} and the partial area _{0.90}A_{Z} under the curves were estimated using Metz's LABROC4 software. (See Reference 26).

The performance of the cluster-detection method for the detection of individual calcifications, using Database I, was: TPDs=(55%±21%) and FPDs =(20%±33%).

These figures were obtained by analyzing only true positive detected clusters. The sensitivity in terms of cluster detection for Database I was 78% with 2.5 false positive clusters per image.

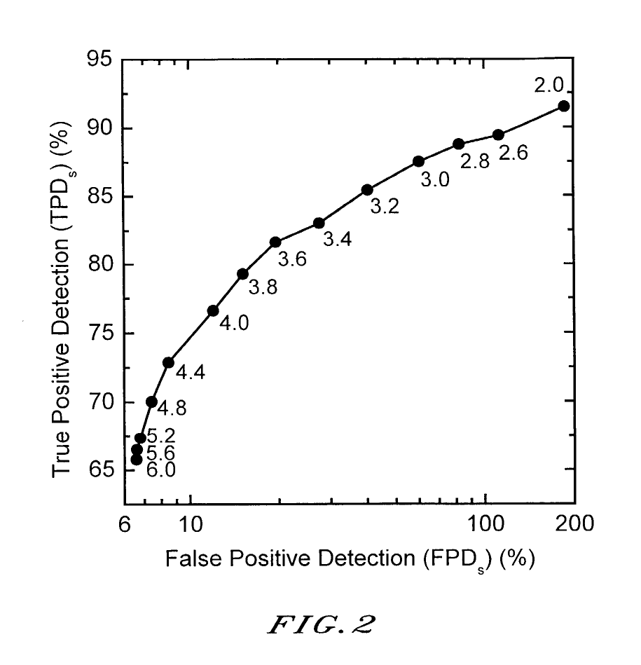

A more accurate identification of individual calcifications was achieved by the calcification-detection method, as shown by the results illustrated in Table 2 and FIG. 2. For 3.6≦k≦6.0, FPDs remained below 20% and TPDs varied between 81% and 66%. For k>5.2, the change in performance was slight, and the TPDs and FPDS remained approximately 66% and 7%, respectively. This resulted from the local thresholding that guaranteed the detection of a minimum number of signals, Sₘᵢₙ, irrespective of the magnitude of k.

When manually identified calcifications from Database I were used as the classifier input, the A_{Z} value equaled 0.92 on a per patient analysis and 0.83 on a per cluster analysis. (See Reference 8). The corresponding partial area indices were 0.82 and 0.48, as shown in Table 3.

TABLE 3
The area A_{z} and partial area _{0.90}A_{z} under the ROC curves obtained
on a per patient and on a per cluster basis, on database I, when the
input of the classification scheme is given by manual
identifications and by the cluster-detection scheme (± indicate
standard deviations).

| | Per patient | | Per cluster | |
|---|---|---|---|---|
| Classifier input | A_{z} | _{0.90}A_{z} | A_{z} | _{0.90}A_{z} |
| Manually | 0.92 ± 0.04 | 0.82 ± 0.08 | 0.83 ± 0.04 | 0.48 ± 0.09 |
| Cluster- | 0.81 ± 0.06 | 0.33 ± 0.16 | 0.79 ± 0.05 | 0.29 ± 0.10 |
| detection | | | | |

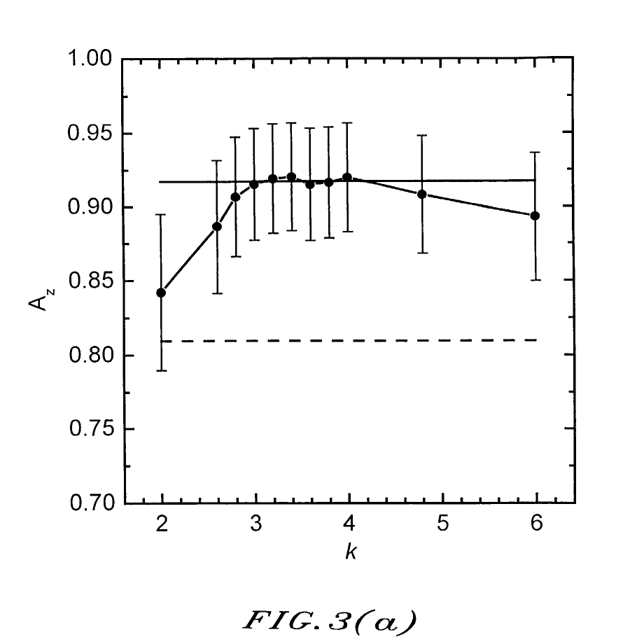

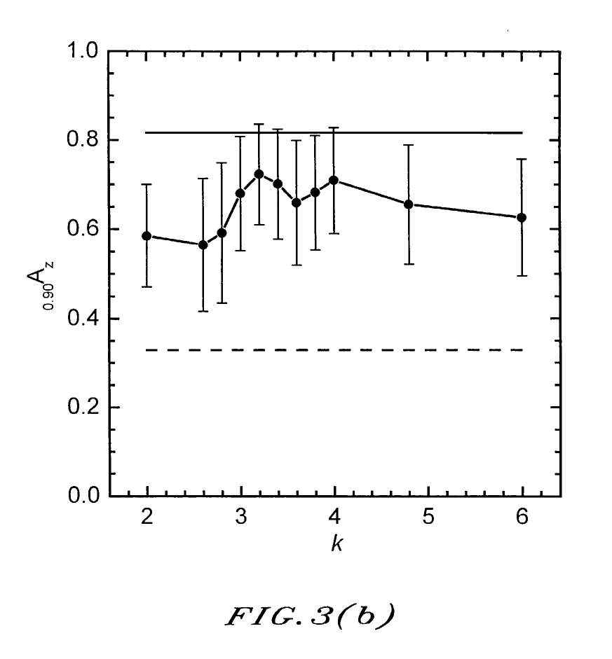

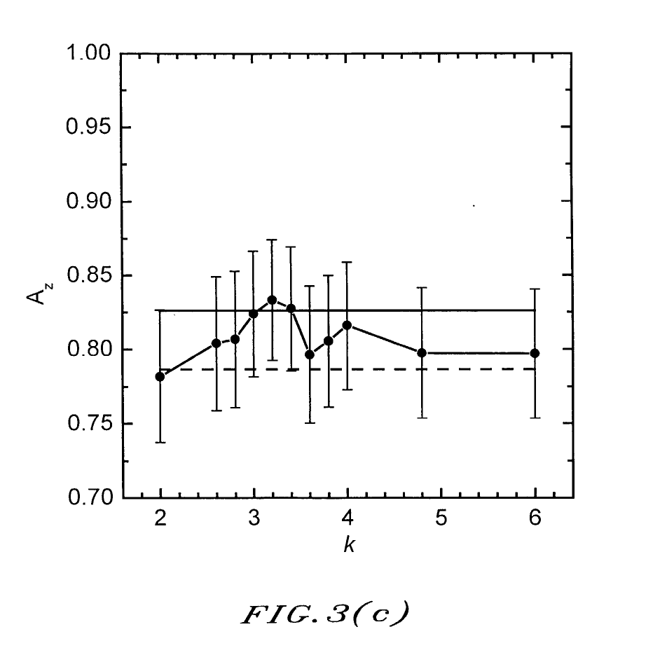

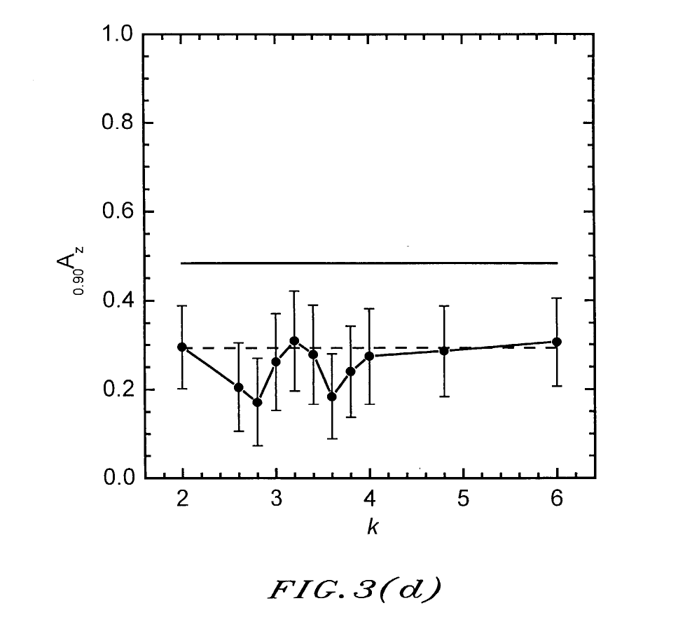

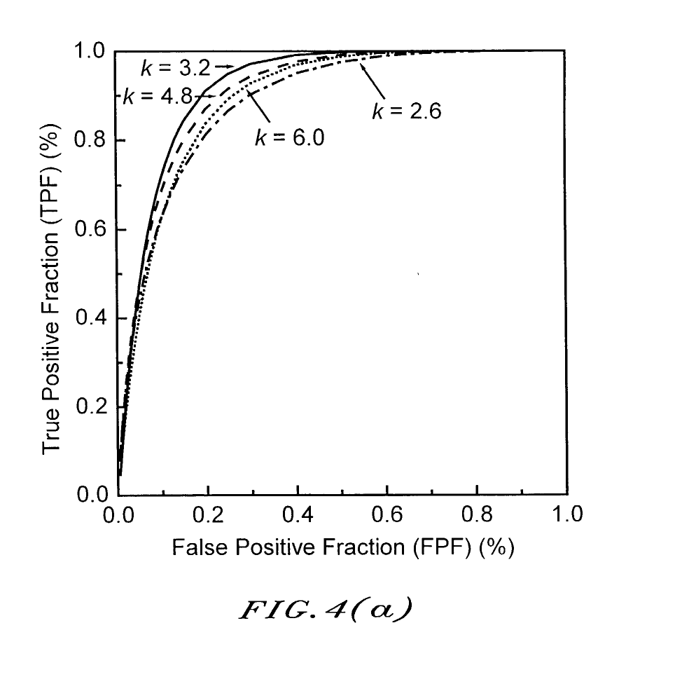

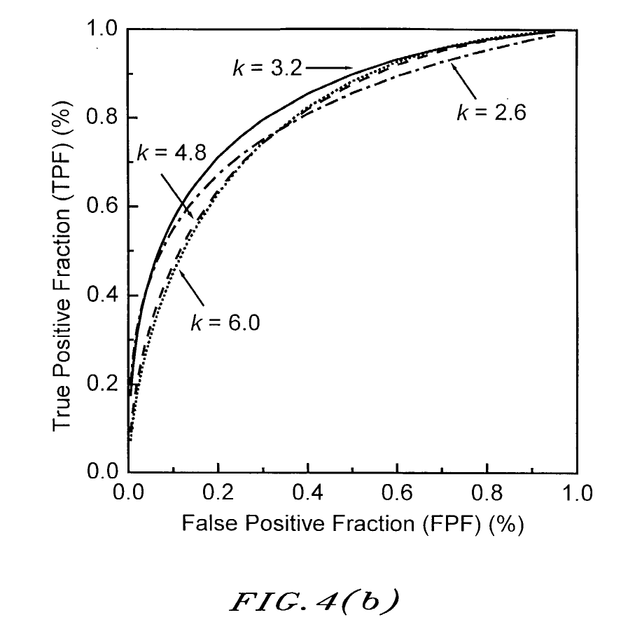

When microcalcifications detected by the cluster-detection method were used as the classifier input, the performance of the classifier was substantially degraded. The area under the ROC curve had a value of 0.81 on a per patient analysis and 0.79 on a per cluster analysis. The corresponding partial area indices were 0.33 and 0.29, as shown in Table 3. This degradation in performance was due to the incorrect detection of individual calcifications (55% TPDs and 20% FPDs) that affected the features used by the ANN to classify the clusters. The A_{Z} and the partial area _{0.90}A_{Z} of the ANN as a function of the calcification detection parameter, k, are shown on a per patient basis in FIGS. 3(a) and 3(b) and on a per cluster basis in FIGS. 3(c) and 3(d). The straight solid and dashed lines represent the index values obtained when the classification method input was provided by manually identified calcifications and by the cluster detection method respectively, as shown in Table 3. For 3.0≦k≦4.0, i.e., for (TPDs, FPDs) pairs between (0.87,0.60) and (0.77,0.12), the classifier performance did not substantially change. This agreed with prior experimental results that reported, for the same database, that when using composite computer detected calcifications the classifier performance remained approximately constant for TPDs>40% (FPDs=0%) and for FPDs<50% (TPDs=42%). (See Reference 21). In the prior study, false positive detection values were always below 50%, as opposed to the present experiment where a wider range of values was analyzed. Higher or lower values of k resulted in poorer performance of the classifier. This is clearer for k<3.0, when FPDs increased more rapidly, than for k>4.0, when the calcification-detection performance varied more moderately with low FPDs values. This variation in A_{Z} and the partial area _{0.90}A_{Z} as a function of k is also apparent in FIGS. 4(a) and 4(b), which show the ROC curves for k=2.6; k=3.2; k=4.8; and k=6.0.

FIGS. 3(a) and 3(c) further illustrate that for 3.0≦k≦4.0, both patient and cluster based A_{Z} values were close to those obtained by using manual identifications and these values were higher than the results obtained by using the cluster-detection method. In the same range of k, the per patient partial area indices _{0.90}A_{Z}, shown in FIG. 3(b), were less than the corresponding value for manual identifications, but well above the value obtained by using the cluster-detection method. The cluster-based _{0.90}A_{Z}, shown in FIG. 3(d), was close to the value obtained by using the cluster-detection method.

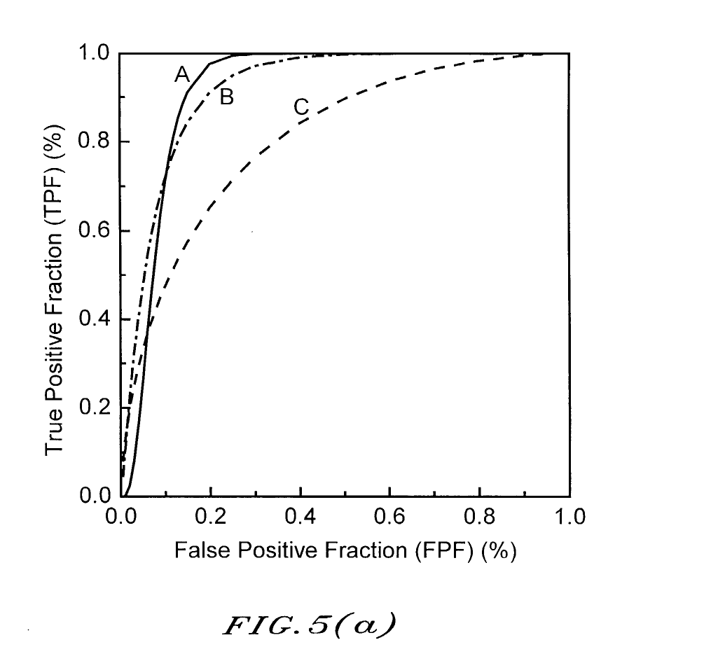

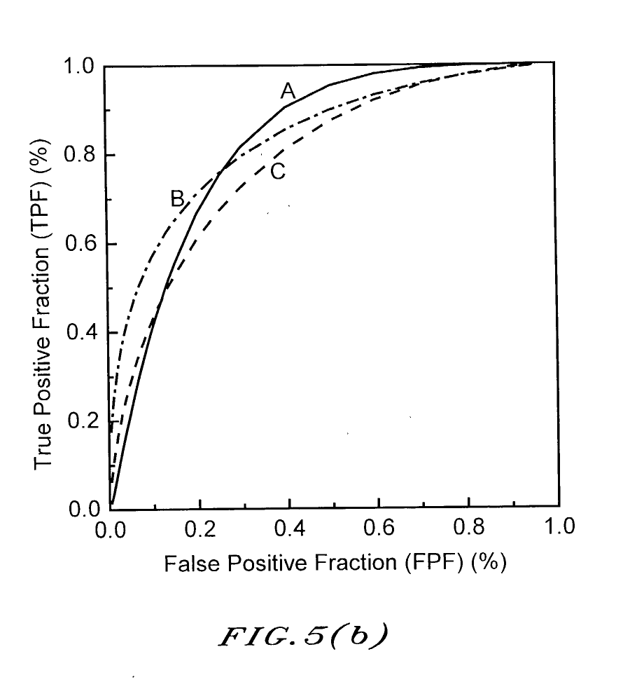

In particular, for k=3.2, the patient based area indices (A_{Z}=0.92 and the partial area _{0.90}A_{Z}=0.72) were substantially higher than the values obtained by generating the classifier input with the cluster-detection method (A_{Z}=0.81 and _{0.90}A_{Z}=0.33) and comparable to the results using manual identification (AZ=0.92 and _{0.90}A_{Z}=0.82). On a per cluster basis, the area index was A_{Z}=0.83, comparable to the manual identification value, A_{Z}=0.82, and higher than the cluster-detection method value A_{Z}=0.79. Its partial area index was _{0.90}A_{Z}=0.31, lower than the value obtained by using manual identifications, _{0.90}A_{Z}=0.48, and only slightly higher than the cluster-detection method value _{0.90}A_{Z}=0.29. these results are also illustrated in the ROC curves of FIGS. 5(a) and 5(b). Curves A and B cross in such a way that the corresponding area indices are very similar while the partial area indices differ. The following Table 4 compares the area and partial area indices, as shown in FIGS. 3(a)-3(d), to the results of manual identifications.

TABLE 4
The area A_{z} and partial area _{0.90}A_{z} indices obtained on
database I (a) by using manually-identified calcifications and
(b) by using the calcification-detection scheme. p-values were
calculated with CLABROC.

| | |
|---|---|
| A_{z} | _{0.90}A_{z} |

| k | (a) | (b) | p-value | (a) | (b) | p-value |
|---|---|---|---|---|---|---|
| Per patient | | | | | | |
| 2.0 | 0.92 | 0.84 | 0.077 | 0.82 | 0.58 | 0.005 |
| 2.6 | 0.92 | 0.89 | 0.233 | 0.82 | 0.56 | 0.005 |
| 3.0 | 0.92 | 0.91 | 0.558 | 0.82 | 0.68 | 0.013 |
| 3.2 | 0.92 | 0.92 | 0.907 | 0.82 | 0.72 | 0.052 |
| 3.4 | 0.92 | 0.92 | 0.774 | 0.82 | 0.70 | 0.066 |
| 3.6 | 0.92 | 0.91 | 0.815 | 0.82 | 0.66 | 0.054 |
| 3.8 | 0.92 | 0.92 | 0.608 | 0.82 | 0.68 | 0.043 |
| 4.0 | 0.92 | 0.92 | 0.855 | 0.82 | 0.71 | 0.077 |
| 4.8 | 0.92 | 0.91 | 0.451 | 0.82 | 0.65 | 0.011 |
| 6.0 | 0.92 | 0.89 | 0.305 | 0.82 | 0.63 | 0.009 |
| Per cluster | | | | | | |
| 2.0 | 0.82 | 0.78 | 0.121 | 0.48 | 0.29 | 0.002 |
| 2.6 | 0.82 | 0.80 | 0.577 | 0.48 | 0.20 | <0.001 |
| 3.0 | 0.82 | 0.83 | 0.636 | 0.48 | 0.26 | 0.001 |
| 3.2 | 0.82 | 0.83 | 0.979 | 0.48 | 0.31 | 0.005 |
| 3.4 | 0.82 | 0.83 | 0.920 | 0.48 | 0.28 | 0.003 |
| 3.6 | 0.82 | 0.80 | 0.248 | 0.48 | 0.18 | <0.001 |
| 3.8 | 0.82 | 0.80 | 0.286 | 0.48 | 0.24 | 0.001 |
| 4.0 | 0.82 | 0.81 | 0.430 | 0.48 | 0.27 | 0.003 |
| 4.8 | 0.82 | 0.80 | 0.186 | 0.48 | 0.28 | 0.030 |
| 6.0 | 0.82 | 0.80 | 0.155 | 0.48 | 0.31 | 0.016 |

The patient based and cluster based area indices A_{Z} values were significantly different from the values obtained using manual identifications. However, as noted previously, the ROC curves obtained by using the calcification-detection method crossed the ROC curves of manual identifications in such a way that the A_{Z} indices did not substantially differ but the _{0.90}A_{Z} values did. The partial area index _{0.90}A_{Z} was not significantly different from the value corresponding to manual identifications only for k=3.2, k=3.4, k=3.6, and k=4.0 in the per patient analysis. These k values corresponded to detection performances, expressed as (TPDs, FPDs) pairs of: (0.85,0.40), (0.83,0.27), (0.82,0.20), and (0.77,0.12) respectively. In the per cluster analysis, the partial area values were always significantly different from the manual identification value.

In spite of the lower partial area index, at k=3.2, 99.75% of cancers were correctly classified on a per patient basis, while 50% of benign cases were classified as malignant. Alternatively, at a false positive fraction of 30%, a sensitivity of 97.1% was achieved. These sensitivity values were not significantly different from those obtained by using manual identifications, as shown in Table 5.

TABLE 5
Comparison between the sensitivity levels achieved by the
ANN cluster classifier on Database I (per patient analysis)
at 30% and 50% false positive fractions, when the classifier
input is provided manually-identified calcifications and by
the calcification-detection scheme with k = 3.2. The
numbers in parenthesis indicate 95% confidence intervals.
p-values were calculated with CLABROC.

| | Manual | Calcification-detection | |
|---|---|---|---|
| | identifications | scheme k = 3.2 | p-value |
| TPF (%) at 30% | 99.87 (71.11, 100) | 97.10 (74.56, 99.91) | 0.12 |
| FPF | | | |
| TPF (%) at 50% | 100 (86.05, 100) | 99.75 (85.59, 100) | 0.09 |
| FPF | | | |

The calcification-detection method with k=3.2 was run on Database II. The calcification-detection method identified 77%±15% of the actual calcifications and 47%±67% false positive detections. When these computer detected signals were used as input to the cluster classifier, the per cluster area index was not significantly different from the value obtained when manually identified signals were used as the classifier input. The per cluster partial area and the per patient total and partial areas were significantly lower than the corresponding values associated to manual identifications, but the differences were not highly significant, as shown in Table 6.

TABLE 6
The area A_{z} and partial area _{0.90}A_{z} obtained on Database II,
by using manually-identified calcifications and by using the
calcification-detection scheme with k = 3.2.

| A_{z} | | | _{0.90}A_{z} | | |
|---|---|---|---|---|---|
| | Calc- | | | Calc- | |
| Manual | Detection | | Manual | Detection | p- |
| Identification | Scheme | p-value | Identification | Scheme | value |
| Per patient | | | | | |
| 0.91 ± 0.02 | 0.85 ± 0.03 | 0.022 | 0.62 ± 0.08 | 0.33 ± 0.10 | 0.016 |
| Per cluster | | | | | |
| 0.93 ± 0.02 | 0.89 ± 0.02 | 0.082 | 0.62 ± 0.07 | 0.44 ± 0.08 | 0.043 |

The calcification-detection method performed better than the cluster-detection method in the task of automatically identifying individual calcifications. The cluster-detection method is optimized for the detection of clusters and not for the detection of individual calcifications, which explains the implementation of an intermediate step to localize individual calcifications more accurately with the calcification-detection method. This more accurate localization is useful during the feature extraction process, which generates the input for the ANN, so that the classifier performance does not become degraded. High fractions of false-positive signals or low fractions of true-positive signals result in lower performance than those obtained using manually identified calcifications. However, when the calcification-detection method was used to identify the calcifications, the observed differences in A_{Z} and _{0.90}A_{Z} were generally not statistically significant.

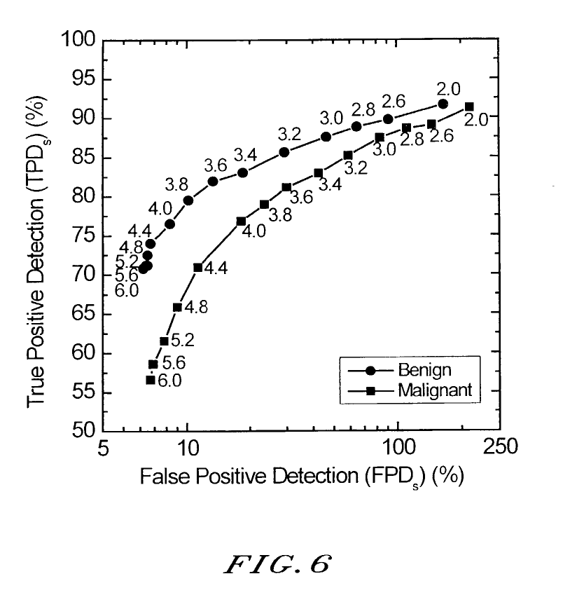

That the partial area indices were consistently lower for computer identifications, when compared with manual identifications, may be explained by analyzing the calcification detection method performance for benign and malignant clusters separate, as shown in FIG. 6. At each value of k, FPDs are higher for malignant than for benign clusters. For k≦4.0, TPDs are similar for benign and malignant cases. For k>4.0, TPDs are lower for malignant than for benign clusters. This difference in performance results from two considerations. First, malignant clusters generally contain more calcifications than benign clusters do. For Database I, for example, the mean number of calcifications was 28 for malignant clusters and 10 for benign clusters. Additionally, the global thresholding kept a disproportionately larger number of signals when the estimated number of calcifications, N, was large. This result is illustrated in Table 1. In Database I, clusters with more than 10 calcifications represented 92 percent of malignant clusters, as opposed to 31 percent of benign clusters. Thus, malignant clusters tended to yield both a higher number of false-positive signals and a higher FPDs value, particularly for k≦4.0. For k>4.0, the difference in FPDs values in malignant and benign clusters was smaller than for k≦4.0, but TPDs in malignant clusters were lower than in benign clusters. As a result, classification results were more degraded for malignant than for benign clusters, when compared to the results obtained using manual identifications. The reduced partial area index represents this degradation.

By eliminating false-positive detections, the classifier performance in the area of higher sensitivity may be further improved. The elimination of false-positive detections may be achieved by redefining the third cluster class (Table 1) and adding a fourth cluster class to avoid detecting an excessive number of signals when N>10. Moreover, employing a neural network that takes as input several signal features may further improve the calcification detection method through a more efficient false-positive reduction step.

Additionally, a fully-automated system could be realized by linking the cluster and calcification detection methods, i.e. to identify the cluster with the cluster-detection method and then to identify the calcifications in that cluster with ht calcification-detection method.

The cluster location and size and the number of calcifications in the cluster may be provided by the cluster-detection method. However, because the cluster-detection method is not optimized for the detection of individual calcifications, the information provided by the cluster-detection method may not be accurate. Thus, the system must be designed to compensate if the cluster-detection method were to be linked to the calcification-detection method.

The calcification-detection method may be improved by additional false-positive reduction methods. Additional false-positive reduction methods would yield higher partial area index values and thus would broaden the range of k values that lead to results comparable to manually identified calcifications.

Presently, the calcification-detection method greatly reduces the amount of time required during manual identification because the radiologist manually identifying the cluster only marks the cluster bounding box and estimates the cluster class according to the number of calcifications present in the cluster. Thus, the calcification-detection method enables the clinical implementation of the cluster-classifier and links the cluster-detection and classification methods with minimal human intervention. Simple human interface is also recommended in a clinical CAD system since it is likely that there will be lesions for a radiologist to examine closely that the computer may not detect.

Because the accuracy of classification of a mass or a mass-like lesion depends on the accuracy of the segmented lesion, improvements in the segmentation of the lesion may improve the classification result. (See Reference 28). A priori information may be used to improve the segmentation. For example, the approximate size and shape characteristics (round, oval, lobular, or irregular), margin (circumscribed, microlobulated, obscured, indistinct, or spiculated), as well as the local breast density could be used to improve the segmentation, in a similar fashion to what has been herein described. Thus, it is evident that using a priori information about the cluster, a higher percentage of individual microcalcifications may be identified. By doing so, classification of the cluster (benign or malignant) may be performed more accurately than manual identification of microcalcifications.

Computer and System

This invention conveniently may be implemented using a conventional general purpose computer or micro-processor programmed according to the teachings of the present invention, as will be apparent to those skilled in the computer art. Appropriate software can readily be prepared by programmers of ordinary skill based on the teachings of the present disclosure, as will be apparent to those skilled in the software art.

As disclosed in cross-referenced U.S. patent application Ser. No. 09/818,831, a computer implements the method of the present invention, wherein the computer housing houses a motherboard which contains a CPU, memory (e.g., DRAM, ROM, EPROM, EEPROM, SRAM, SDRAM, and Flash RAM), and other optical special purpose logic devices (e.g., ASICS) or configurable logic devices (e.g., GAL and reprogrammable FPGA). The computer also includes plural input devices, (e.g., keyboard and mouse), and a display card for controlling a monitor. Additionally, the computer may include a floppy disk drive; other removable media devices (e.g. compact disc, tape, and removable magneto-optical media); and a hard disk or other fixed high density media drives, connected using an appropriate device bus (e.g., a SCSI bus, an Enhanced IDE bus, or an Ultra DMA bus). The computer may also include a compact disc reader, a compact disc reader/writer unit, or a compact disc jukebox, which may be connected to the same device bus or to another device bus.

As stated above, the system includes at least one computer readable medium. Examples of computer readable media are compact discs, hard disks, floppy disks, tape, magneto-optical disks, PROMS (e.g., EPROM, EEPROM, Flash EPROM), DRAM, SRAM, SDRAM, etc. Stored on any one or on a combination of computer readable media, the present invention includes software for controlling both the hardware of the computer and for enabling the computer to interact with a human user. Such software may include, but is not limited to, device drivers, operating systems and user applications, such as development tools. Such computer readable media further includes the computer program product of the present invention for performing the inventive method herein disclosed. The computer code devices of the present invention can be any interpreted or executable code mechanism, including but not limited to, scripts, interpreters, dynamic link libraries, Java classes, and complete executable programs. Moreover, parts of the processing of the present invention may be distributed for better performance, reliability, and/or cost. For example, an outline or image may be selected on a first computer and sent to a second computer for remote diagnosis.

The invention may also be implemented by the preparation of application specific integrated circuits or by interconnecting an appropriate network of conventional component circuits, as will be readily apparent to those skilled in the art.

Numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A method of detecting a calcification in a bounding box enclosing a portion of a medical image, comprising the steps of:
obtaining the medical image in digital form;
filtering at least image data in the bounding box; and
thresholding the filtered image data to detect, as one or more calcifications, portions of the filtered image data which exceed a threshold.

2. The method according to claim 1, wherein the filtering step comprises:
filtering at least image data in the bounding box using a Difference of Gaussians (DOG) filter.

3. The method according to claim 1, wherein the filtering step comprises:
filtering at least image data in the bounding box using a box-rim filter.

4. The method according to claim 1, wherein the filtering step comprises:
filtering at least image data in the bounding box using a wavelet filter.

5. The method according to claim 1, wherein the filtering step comprises:
filtering at least image data in the bounding box using a bandpass filter.

6. The method according to claim 1, further comprising:
delineating a region of interest (ROI) surrounding the bounding box; and
filtering the ROI using a DOG filter.

7. The method according to claim 1, further comprising:
delineating a region of interest (ROI) surrounding the bounding box; and
filtering the ROI using a box-rim filter.

8. The method according to claim 1, further comprising:
delineating a region of interest (ROI) surrounding the bounding box; and
filtering the ROI using a wavelet filter.

9. The method according to claim 1, further comprising:
delineating a region of interest (ROI) surrounding the bounding box; and
filtering the ROI using a bandpass filter.

10. The method according any one of claims 6 to 9, further comprising:
outputting center of mass coordinates of detected calcifications.

11. The method according to claim 1, wherein the delineating step comprises:
adding margins to edges of the bounding box to include in the ROI pixels in the medical image surrounding the bounding box.

12. The method according to claim 1, wherein the thresholding step comprises:
globally thresholding the filtered image data.

13. The method according to claim 12, wherein the globally thresholding step is performed iteratively.

14. The method according to claim 12, wherein the globally thresholding step further comprises:
determining whether each pixel of the filtered image data is within a range, R_{c}; and
selecting the range, R_{c}, as a function of an approximate number of calcifications in the bounding box.

15. The method according to claim 14, wherein the globally thresholding step is performed iteratively.

16. The method according to claim 12, wherein the thresholding step comprises:
locally thresholding the filtered image data.

17. The method according to claim 16, wherein the locally thresholding step is performed iteratively.

18. The method according to claim 16, wherein the locally thresholding step further comprises:
determining whether each pixel of the filtered image data is within a range, Sₘᵢₙ; and
selecting the range, Sₘᵢₙ, as a function of an approximate number of calcifications in the bounding box.

19. The method according to claim 18, wherein the locally thresholding step is performed iteratively.

20. The method according to claim 15 further comprising:
locally thresholding the filtered image data.

21. The method according to claim 20, wherein the locally thresholding step further comprises:
determining whether each pixel of the filtered image data is within a range, Sₘᵢₙ; and
selecting the range, Sₘᵢₙ, as a function of an approximate number of calcifications in the bounding box.

22. The method according to claim 21, wherein the locally thresholding step is performed iteratively.

23. A method of classifying tissue in a bounding box enclosing a portion of a medical image, comprising the steps of:
obtaining the medical image in digital form;
filtering at least image data in the bounding;
thresholding the filtered image data to detect, as one or more detected calcifications, portions of the filtered image data which exceed a threshold;
segmenting the one or more detected calcifications;
extracting at least one feature from the one or more segmented calcifications; and
determining a likelihood of malignancy of the one or more detected calcifications.

24. The method according to claim 23, wherein the filtering step comprises:
filtering at least image data in the bounding box using a Difference of Gaussians (DOG) filter.

25. The method according to claim 23, wherein the filtering step comprises:
filtering at least image data in the bounding box using a box-rim filter.

26. The method according to claim 23, wherein the filtering step comprises:
filtering at least image data in the bounding box using a wavelet filter.

27. The method according to claim 23, wherein the filtering step comprises:
filtering at least image data in the bounding box using a bandpass filter.

28. The method according to claim 23, further comprising:
delineating a region of interest (ROI) surrounding the bounding box; and
filtering the ROI using a DOG filter.

29. The method according to claim 23, further comprising:
delineating a region of interest (ROI) surrounding the bounding box; and
filtering the ROI using a box-rim filter.

30. The method according to claim 23, further comprising:
delineating a region of interest (ROI) surrounding the bounding box; and
filtering the ROI using a wavelet filter.

31. The method according to claim 23, further comprising:
delineating a region of interest (ROI) surrounding the bounding box; and
filtering the ROI using a bandpass filter.

32. The method according to any one of claims 28-31, wherein the delineating step comprises:
adding margins to edges of the bounding box to include in the ROI pixels in the medical image surrounding the bounding box.

33. The method according to claim 23, wherein the thresholding step comprises:
globally thresholding the filtered image data.

34. The method according to claim 33, wherein the globally thresholding step is performed iteratively.

35. The method according to claim 34, wherein the globally thresholding step further comprises:
determining whether each pixel of the filtered image data is within a range, R_{c}; and
selecting the range, R_{c}, as a function of an approximate number of calcifications in the bounding box.

36. The method according to claim 35, wherein the globally thresholding step is performed iteratively.

37. The method according to claim 33, wherein the thresholding step comprises:
locally thresholding the cluster of calcifications.

38. The method according to claim 37, wherein the locally thresholding step is performed iteratively.

39. The method according to claim 37, wherein the thresholding step further comprises:
determining whether each pixel of the filtered image data is within a range, Sₘᵢₙ; and
selecting the range, Sₘᵢₙ, as a function of an approximate number of calcifications in the bounding box.

40. The method according to claim 39, wherein the locally thresholding step is performed iteratively.

41. The method according to claim 36 further comprising:
locally thresholding the filtered image data.

42. The method according to claim 41, wherein the locally thresholding step further comprises:
determining whether each pixel of the filtered image data is within a range, Sₘᵢₙ; and
selecting the range, Sₘᵢₙ, as a function of an approximate number of calcifications in the bounding box.

43. The method according to claim 42, wherein the locally thresholding step is performed iteratively.

44. The method according to claim 23, wherein the determining step comprises:
applying the extracted features to an artificial neural network (ANN); and
determining the detected abnormality to be an actual abnormality based on the output of the ANN.

45. The method according to claim 44 wherein the applying step comprises:
applying the extracted features into an ANN with one hidden layer of six units and an output layer of one unit.

46. The method according to claim 45, wherein the extracting step further comprises:
extracting at least one feature from the group comprising: area of the cluster, shape of the cluster, number of calcifications in the cluster, average effective volume of microcalcifications (for individual calcifications and for the cluster), relative standard deviation in effective volume (for individual calcifications and for the cluster), relative standard deviation in effective thickness (for individual calcifications and for the cluster), average area of microcalcifications (for individual calcifications and for the cluster), and the shape of the microcalcifications.

47. A system implementing the method of any one of claims 1-46.

48. A computer program product storing instructions for execution on a computer system, which when executed by the computer system, cause the computer system to perform the method recited in any one of claims 1-46.
